(19) United States
(12) Patent Application Publication
(10) Pub. No.: US 2024/0054764 A1
(43) Pub. Date: Feb. 15, 2024

(54) SYSTEM AND METHOD FOR UNSUPERVISED OBJECT DEFORMATION USING FEATURE MAP-LEVEL DATA AUGMENTATION

(71) Applicant: CARNEGIE MELLON UNIVERSITY, Pittsburgh, PA (US)

(72) Inventors: Ran Tao, Pittsburgh, PA (US); Marios Savvides, Pittsburgh, PA (US); Han Zhang, Pittsburgh, PA (US)

(21) Appl. No.: 18/267,543

(22) PCT Filed: Feb. 4, 2022
(86) PCT No.: PCT/US22/15263

§ 371 Date: Jun. 15, 2023

Related U.S. Application Data
(60) Provisional application No. 63/148,851, filed on Feb. 12, 2021.

(51) Int. Cl. G06V 10/771

(52) U.S. Cl. CPC G06V 10/771

(57) ABSTRACT

Disclosed herein is a methodology implementing feature map-level data augmentation in a feature map. Two or more units in the feature map are selected and the values of locations in the two or more units are swapped among the two or more units. Value perturbations applied around local units in the feature map implicitly lead to an unused data augmentation at the image level.

### RELATED APPLICATIONS

This application claims the benefit of U.S. Provisional Patent Application No. 63/148,851, filed Feb. 12, 2021, the contents of which are incorporated herein in their entirety.

### BACKGROUND

Data augmentation for neural networks is important technique for regularization methods. Deep neural networks are an efficient solution for many different scenarios with large-scale training, such as image classification, object detection and image segmentation. One crucial issue for the training of deep neural networks is the over-fitting problem. In a deep neural network with a large number of parameters, generalization must be considered because the training of parameters could be easily fitted to the training dataset.

As this issue is addressed, data augmentation is an efficient method to introduce variations during training. Data augmentation on the image side generally covers three types, namely transformation, color and information dropping. For information dropping, techniques such as Cutout and Gridmask use methods wherein some image parts are randomly dropped. Similar techniques such as Dropblock, may be applied to feature maps (i.e., convolutional layer activations) for information dropping. However, variations existing in the real-world generally cover more complicated cases, such as object deformation.

For example, as shown in FIG. 1, products on a retail shelf may be deformed as compared to a frontal view of the product. FIG. 1 shows examples of different object deformations in training and testing cases. Images in real scenarios generally contain objects with deformations which may not be covered in a training dataset and these types of object deformations are difficult to achieve using image-level data augmentation.

### SUMMARY

Disclosed herein is a system and method for data augmentations which is performed at the feature map level. Such data augmentations at the feature map level can be related to image-level data augmentations, such as object deformation. The relation between feature map-level augmented data points and augmentations at the image level can be applied to deep neural networks. Value perturbations applied around local units in a feature map could implicitly lead to an unused data augmentation at the image level.

The data augmentation method disclosed herein operates at the feature map level and is designed to exchange values from two or more randomly sampled units in the feature map. A new representation for objects is thus introduced, and, as such, variations of object deformations are invoked without altering the semantic meaning that the feature maps represent. Implementations of the method involve a plug-in augmentation module referred to herein as “E-module” that can be used for both general classification as well as few-shot classification.

### BRIEF DESCRIPTION OF THE DRAWINGS

By way of example, a specific exemplary embodiment of the disclosed system and method will now be described, with reference to the accompanying drawings, in which:

FIG. 1 illustrates different examples of object deformation in training and testing datasets.

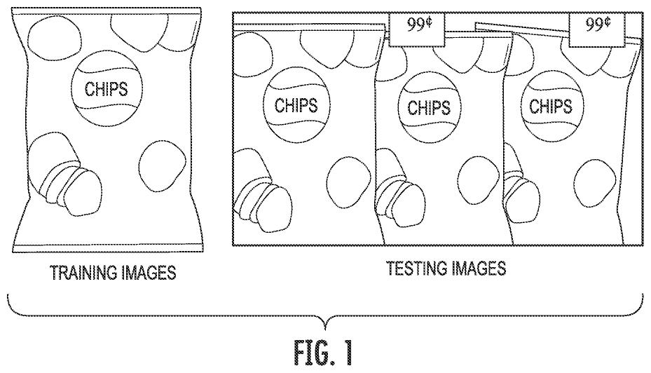

FIG. 2 illustrates how feature map augmentation related to some unused augmentation kernel in the image space.

FIG. 3 is an illustration of feature maps with original images being augmented using the swapblock algorithm.

FIG. 4 is a meta-language listing of one possible embodiment of the swapblock algorithm.

### DETAILED DESCRIPTION

To understand the present invention, it is necessary to first understand different aspects of data augmentation methods. The kernel theory of modern data augmentation relates the image level transformation with the statistical expectation on the feature map level. For a general kernel classifier, assume an original kernel K with a finite-dimension feature map ϕ: [symbol] ^{d}→ [symbol] ^{D} and the convex loss to be minimized is l: [symbol] × [symbol] → [symbol] with parameter w= [symbol] ^{D} over a dataset (x₁, y₁), . . . , (xₙ, yₙ). In classification, the original objective function is to minimize:

$$f ( ) = \frac{1}{n} {\sum }_{i = 1}^{n} l ( {T}^{} ϕ ( {x}_{i} ) ; {y}_{i} ) \qquad ( 1 )$$

Suppose the dataset is first augmented using an augmentation kernel T. For each data point xᵢ, T(xᵢ) describes the distribution over data points into which xᵢ can be transformed. The new objective function becomes:

$$g ( ) = \frac{1}{n} {\sum }_{i = 1}^{n} {E}_{{t}_{i} \sim T ( {x}_{i} )} [ l ( {T}^{} ϕ ( {x}_{i} ) ; {y}_{i} ) ] \qquad ( 2 )$$

By using a first-order Taylor approximation, each term can be expanded around any point ϕ₀ that does not depend on

Eₜ_{ᵢ}_{˜T(x}_{ᵢ}₎[l(w^{T}ϕ(xᵢ);yᵢ)]≈l(w^{T}ϕ₀;yᵢ)+Eₜ_{ᵢ}_{˜T(x}_{ᵢ}₎[w^{T}(ϕ₀−ϕ(tᵢ))]l′(w^{T}ϕ₀;yᵢ) (3)

Picking ϕ₀=Eₜ_{ᵢ}_{˜T(x}_{ᵢ}₎[ϕ(tᵢ)], the second term vanishes, yielding the first order approximation:

$$g ( ) \approx ( \hat{g} ) ( ) := \frac{1}{n} {\sum }_{i = 1}^{n} ( {T}^{} {E}_{{t}_{i} \sim T ( {x}_{i} )} [ ϕ ( l ) ] ; {y}_{i} ) \qquad ( 4 )$$

This is exactly the objective of a linear model with a new feature map ψ(x)=E_{t˜T(x)}[ϕ(t)], which is the average feature of all the transformed versions of x. The objective can be approximated to a first order by a term that computes the average augmented feature of each data point. This indicates the relations between image level data augmentation and the feature maps, which is that the effects of learning from the augmented data points can be approximated by averaging the feature maps of the augmented data points for a kernel classifier.

Besides linear models, deep neural networks are practically used in general classification problems. In a deep neural network, let the first k layers define a feature map ϕ, and the remaining layers define a non-linear function ƒ(ϕ(x)). The data augmentation is defined as T, and the loss on each data point is then of the form Eₜ_{ᵢ}_{˜T(x}_{ᵢ}₎[l(ƒ(ϕ(xᵢ); yᵢ)]. Similar to Eq. (2), the objective is given by:

$$f ( ) = \frac{1}{n} {\sum }_{i = 1}^{n} {E}_{{t}_{i} \sim T ( {x}_{i} )} [ l ( f ( ϕ ( {x}_{i} ) ) ; {y}_{i} ) ] \qquad ( 5 )$$

While considering the non-convexity of the objective, the above analysis of Eq. (4) cannot strictly work in this case. For deep nets, the expectation of the feature map with augmented data points ψ(x)=E_{t˜T(x)}[ϕ(t)] can serve as approximation effects to the classifier.

As mentioned above, ψ(x)=E_{t˜T(x)}[ϕ(t)] is the expectation of feature maps with augmented data points. With a specific data augmentation T there exists a T(xᵢ) which describes the distribution over data points into which xᵢ can be transformed.

Generally, in real cases, the image-level data augmentation is applied within a set of different data augmentations like rotation, cropping, flipping, etc. Thus, the data augmentation can be expanded with Tⱼ where j can refer to a specific data augmentation or some effects of combinations of the known data augmentation methods. If it assumed that the data augmentation of each j could work as an independent and identically distributed random variable, then Eₜ_{ⱼ}_{˜T}_{ⱼ}₍ₓ₎[ϕ(tⱼ)] describes the distribution over data points into which different data augmentation represents in the feature map level while j varies.

For a certain data point xᵢ with augmentation kernel Tⱼ, the feature map in one intermediate layer is ϕ(Tⱼ(xᵢ)). An augmentation operation S on the feature map serves to acquire values around ϕ(Tⱼ(xᵢ)) following the value distribution of functional E_{t˜T}_{ⱼ}₍ₓ₎[ϕ(t)]. Then the augmented feature map becomes: S(ϕ(Tⱼ(xᵢ)))=ϕ(Tⱼ(xᵢ))+θᵢⱼ, where θᵢⱼ refers to variations of unit values. Then:

$${E}_{{t}_{j} \sim {T}_{j} ( x )} [ S ( ϕ ( {T}_{j} ( x ) ) ) ] = {E}_{{t}_{j} \sim {T}_{j} ( x )} [ ϕ ( {T}_{j} ( x ) ) + {θ}_{j} ] \qquad ( 6 )$$

$$= {E}_{{t}_{j} \sim {T}_{j} ( x )} [ ϕ ( {T}_{j} ( x ) ) ] + {E}_{{t}_{j} \sim {T}_{j} ( x )} [ {θ}_{j} ]$$

Eₜ_{ⱼ}_{˜T}_{ⱼ}₍ₓ₎ [θⱼ] introduces some value shift around Eₜ_{ⱼ}_{˜T}_{ⱼ}₍ₓ₎[ϕ(Tⱼ(x))]. As T varies, the effect of this operation is to implicitly introduce some data augmentation Tₖ on the image level without actually applying it on the data points, where E_{t˜T}_{ₖ}₍ₓ₎[ϕ(t)]=E_{t˜T}_{ⱼ}₍ₓ₎[ϕ(t)]+Eₜ_{ⱼ}_{˜T}_{ⱼ}₍ₓ₎[θⱼ].

Through the above analysis, it can be concluded that having a well-designed augmentation operation S on feature maps, an augmentation Tₖ can be inferred on the image level without actually applying it to the data points. However, the design of S assumes that the actual value distribution of Eₜ_{ⱼ}_{˜T}_{ⱼ}₍ₓ₎[ϕ(Tⱼ(x))] is actually unknown.

Feature Map-Level Augmentations

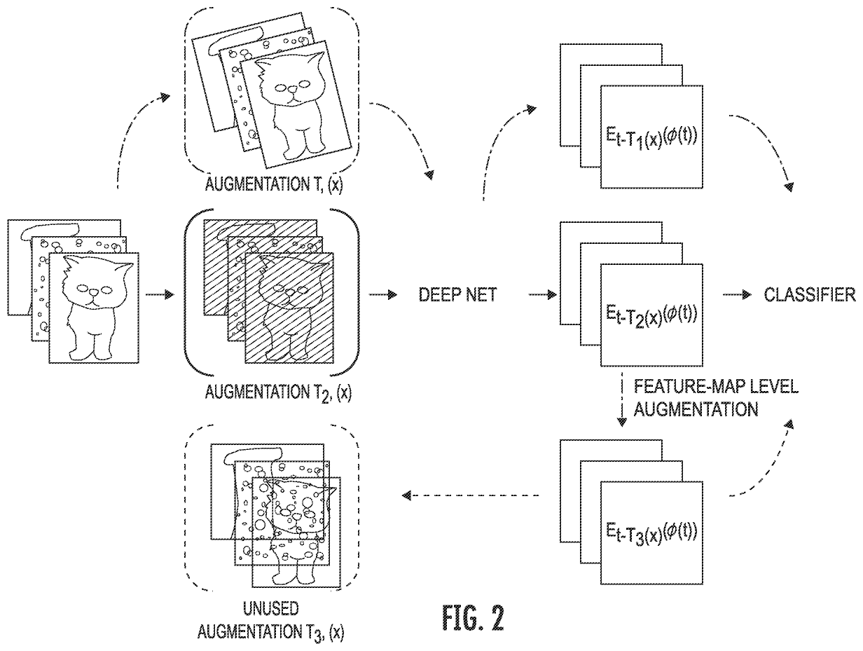

FIG. 2 is an illustration showing that different augmentation kernels T relate to different expected feature maps ψ(x)=E_{t˜T(x)}[ϕ(t)] in a deep neural network. By applying the feature map augmentation, the value of ψ(x)=E_{t˜T(x)}[ϕ(t)] is expected to shift, which implicitly relates to some unused augmentation kernel on the image side

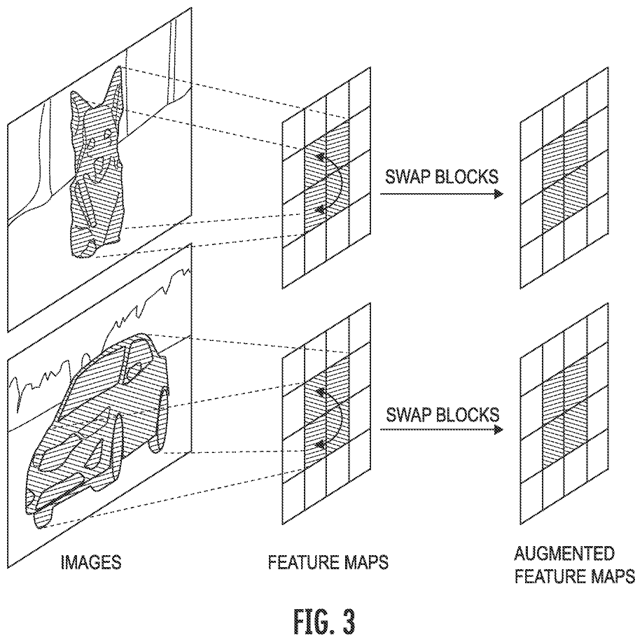

Regarding the feature maps of intermediate layers, as shown in FIG. 3, values on feature maps are responses of specific convolution filters. Due to the shifting property of convolution, values in the neighboring units are expected to encode similar information referring to either an object or to the background. In other words, neighboring values together encode the representation of an object in feature maps. The values exchanged in the neighboring units correspond to a new representation for that object while the same categorical information for the object is unchanged. This enlightens the design of the operation S disclosed herein. The novel technique of the present invention swaps the values of two randomly-selected units in neighboring areas of the feature map. This will change the local values but will still follow the response that encodes the object information in the feature map. The applied augmentation is “local” in the sense that it does not significantly modify the feature map and thus keeps the categorical information unchanged while introducing new object representations.

The E-module is a plug-in module for a deep neural network that implements an algorithm, referred to herein as “swapblock”, which is disclosed herein and which implements feature map-level augmentation for deep neural networks. The details of the swapblock algorithm will now be disclosed. The main function of the swapblock algorithm is to randomly sample sets of two units in neighboring areas of the feature map and to exchange information between the selected units during training. In a feature map, a unit is generally a 3-D tensor with the size of H×W×D, wherein H×W is the spatial height and width and D is the depth. Herein, a unit is defined as the feature length (D) on each spatial location of H×W. To achieve the value swap efficiently, the algorithm is applied across all channels for one feature map and is not applied to keep the object representation precise during inference. The swapblock algorithm takes a feature map and three parameters as its input. The three parameters are the maximum size of the units, the maximum of range of the shifting and the sampling probability.

Maximum Unit Size—In the implementation of the swapblock algorithm, a unit size is, in one embodiment, randomly generated to fall within a range limited by the maximum unit size parameter. Using a range of unit sizes rather than a fixed unit size adds more variations considering different unit sizes could lead to different extents of variations. In alternate embodiments, methods other than random selection may be used.

Maximum Shifting Range—This parameter defines the maximum limit of the spatial range of the units which will swap values. That is, the maximum distance between exchanging units will be randomly selected within a range limited by the maximum shifting range parameter. In other embodiment, other methods selecting the exchanging units may be used.

Sampling Probability—The sampling probability is a probability threshold for the Bernoulli distribution which is applied at every location of a feature map. The Bernoulli distribution, in one embodiment, is used to evaluate each location on the feature map and to randomly select those locations that will serve as centroids of the first unit of the two or more exchanging units. In other embodiments, other methods may be used to select the first unit.

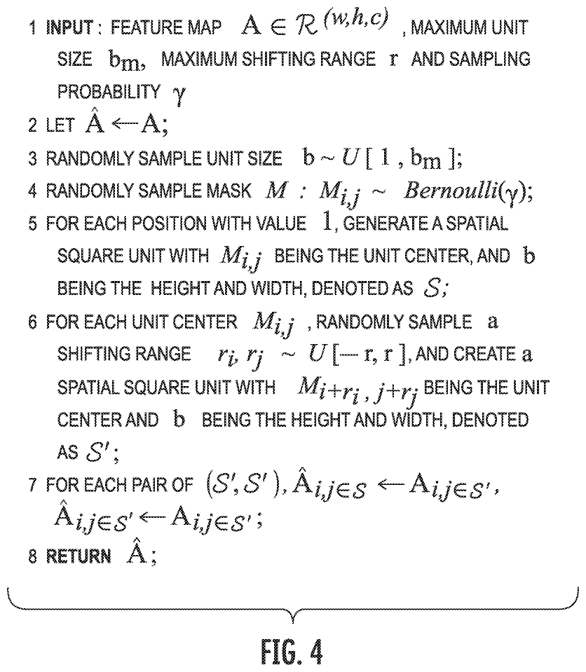

The meta-language listing of one possible embodiment of the swapblock algorithm is shown FIG. 4. In this exemplary embodiment, the algorithm works in the following manner to exchange values between two units: (1) Bernoulli sampling under the sampling probability is run at every location on the feature map to decide if the location will define a first unit in the exchanging pairs of units. The first unit, the size of which is in a range limited by the maximum unit size parameter, is defined with the location as the centroid of the unit; (2) there is a random sampling of the location on the feature map which will serve to defined the second unit. The distance between the location defining the first unit and the location defining the second unit falls with a range limited by the maximum shifting range parameter; (3) the vales of locations in the first and second units are exchanged; and (4) the feature map having the exchanged values is the output of the swapblock algorithm.

In one possible embodiment, with respect to the Bernoulli sampling under the sampling probability, for each location on the feature map chosen by the Bernoulli sampling, that location is selected as the centroid of the first unit and the other unit(s) are selected based on the location of the first unit. In other embodiments, other sampling methods may be used for each location on the feature map.

Note that many variations of the disclosed algorithm are possible and are intended to be within the scope of the invention. For example, in alternate embodiments, three or more units could be chosen, and the values swapped between the three or more units in a similar manner as with two units. In yet another alternative embodiment, only a subset of the values of the locations in each unit may be exchanged. The values to be exchanged may be selected, for example, randomly or by any other method. In yet another alternative embodiment, other methods of choosing the two or more units may be used. In yet another alternative embodiment, the shifting range may be determined in other ways.

As would be realized by one of skill in the art, the disclosed method described herein can be implemented by a system comprising a processor and memory, storing software that, when executed by the processor, performs the functions comprising the method.

As would further be realized by one of skill in the art, many variations on implementations discussed herein which fall within the scope of the invention are possible. Moreover, it is to be understood that the features of the various embodiments described herein were not mutually exclusive and can exist in various combinations and permutations, even if such combinations or permutations were not made express herein, without departing from the spirit and scope of the invention. Accordingly, the method and apparatus disclosed herein are not to be taken as limitations on the invention but as an illustration thereof. The scope of the invention is defined by the claims which follow.

1. A method implementing feature map-level data augmentation in a classifier comprising:
selecting a first unit on the feature map;
selecting one or more additional units on the feature map; and
swapping values among the selected units.

2. The method of claim 1 wherein a size of the two or more units is randomly selected in a range limited by a maximum unit size parameter.

3. The method of claim 2 wherein a distance between the two or more units is randomly selected in a range limited by a maximum shifting range parameter.

4. The method of claim 1 wherein the values of locations in each unit to be swapped between the two or more units is determined randomly.

5. The method of claim 1 wherein the two or more units are randomly selected on the feature map.

6. The method of claim 5 further comprising:
applying Bernoulli sampling under a sampling probability parameter to select a plurality of locations on the feature map to be used as first units.

7. The method of claim 6 wherein the Bernoulli sampling is run for each location on the feature map.

8. The method of claim 7 further comprising:
for each location selected by the Bernoulli sampling:
generating the first unit with the location being the centroid of the first unit;
generating a shifting range;
generating one or more additional units having unit centroids within the shifting range; and
swapping values among the two or more units.

9. The method of claim 9 wherein the size of the size of the two or more units is randomly selected.

10. The method of claim 10 wherein the shifting range is randomly selected.

11. The method of claim 8 wherein the two or more units are spatially square units having a depth.

12. The method of claim 11 wherein values at each location in the units are swapped.

13. The method of claim 8 further comprising selecting specific locations in the unit whose values are swapped.

14. The method of claim 13 wherein the specific locations whose values are swapped are randomly selected.

15. A system comprising:
a processor; and
memory, storing software that, when executed by the processor, performs the method of claim 8.

16. A method implementing feature map-level data augmentation in a classifier comprising:
for each location on the feature map:
performing a Bernoulli sampling under a sampling probability;
for each location chosen by the Bernoulli sampling:
generating a first unit having a centroid at the location;
randomly generating a shifting range;
randomly generating one or more additional units having unit centroids within the shifting range; and
swapping values among the two or more units.
